(19) United States
(12) Patent Application Publication
(10) Pub. No.: US 2006/0260428 A1
(43) Pub. Date: Nov. 23, 2006

(54) BICYCLE SHIFT OPERATING DEVICE WITH A MULTI-DIRECTION OPERATING MEMBER

(75) Inventors: TATSUYA KAWAKAMI, Sakai-ku, Sakai City (JP); ETSUYOSHI WATARAI, Izumi (JP)

Correspondence Address: DELAND LAW OFFICE, P.O. BOX 69, KLAMATH RIVER, CA, 96050-0069, US

(73) Assignee: SHIMANO, INC., Sakai City (JP)

(21) Appl. No.: 11/419,806

(22) Filed: May 23, 2006

(30) Foreign Application Priority Data
May 23, 2005 (JP) 2005-149615
Nov. 30, 2005 (JP) 2005-346205

(51) Int. Cl. F16C 1/10

(52) U.S. Cl. 74/502.2

(57) ABSTRACT

a shift operating device for a bicycle comprises a mounting member structured to be mounted to the bicycle, a cable coupling member coupled to the mounting member for moving a cable in a cable pulling direction and a cable releasing direction, a positioning unit that selectively maintains the cable coupling member in a plurality of operating positions, a first operating member that moves in a first direction and in a second direction different from the first direction, and a transmission unit that transmits movement of the first operating member to the positioning unit such that the cable coupling member moves from an origin operating position toward a destination operating position when the first operating member moves in either of both the first direction and the second direction.

### BACKGROUND OF THE INVENTION

The present invention is directed to bicycles and, more particularly, to a bicycle shift operating device with a multi-direction operating member.

Most bicycles include a transmission that allows the bicycle to be pedaled at a desired gear ratio. A shift control device mounted to the handlebars and connected to the transmission by a cable often controls the transmission by pulling and releasing the cable. The shift control device typically includes a winding member that pulls (winds) and releases (unwinds) the cable, a winding lever that causes the winding member to pull the control cable, and a release lever that causes the winding member to release the cable. Some shift control devices operate by moving the winding and release levers in the same direction (e.g., Japanese Patent No. 2730555), usually by pushing each lever using the thumb, whereas other shift control devices operate by moving the winding and release levers in opposite directions (e.g., Japanese Patent No. 3065656), usually by pushing the winding lever with the thumb and by pulling the release lever with the index finger. However, some riders may prefer to operate a particular lever in a direction opposite the conventionally designed direction in order to either wind or release the cable.

### SUMMARY OF THE INVENTION

The present invention is directed to various features of a bicycle shift control device. In one embodiment, a shift operating device for a bicycle comprises a mounting member structured to be mounted to the bicycle, a cable coupling member coupled to the mounting member for moving a cable in a cable pulling direction and a cable releasing direction, a positioning unit that selectively maintains the cable coupling member in a plurality of operating positions, a first operating member that moves in a first direction and in a second direction different from the first direction, and a transmission unit that transmits movement of the first operating member to the positioning unit such that the cable coupling member moves from an origin operating position toward a destination operating position when the first operating member moves in either of both the first direction and the second direction. Additional inventive features will become apparent from the description below, and such features alone or in combination with the above features may form the basis of further inventions as recited in the claims and their equivalents.

### BRIEF DESCRIPTION OF THE DRAWINGS

FIG. 1 is a side view of a particular embodiment of a bicycle;

FIG. 2 is an oblique view of a particular embodiment of a shift control device mounted to the handlebar;

FIG. 3 is an exploded view of a first embodiment of a shift control device;

FIGS. 4-8 are schematic views of a cable releasing operation;

FIG. 9 is a schematic view of a one-way clutch associated with a winding lever;

FIG. 10 is a schematic view of a pair of one-way clutches associated with a release lever;

FIG. 11 is an exploded view of a second embodiment of a shift control device;

FIG. 12 shows a positioning unit maintaining a cable coupling member in a selected operating position;

FIG. 13 shows a release lever in a start position;

FIG. 14 shows the release lever being moved in a first direction;

FIG. 15 shows the release lever being moved in a second direction;

FIG. 16 shows the positioning unit when the release lever is in the start position;

FIGS. 17-21 show the positioning unit during multiple cable releasing operations;

FIG. 22 is a plan view of a third embodiment of a shift control device;

FIG. 23 is an exploded view of the shift control device;

FIG. 24 is a plan view of a positioning unit;

FIGS. 25A-25C are schematic views illustrating a cable releasing operation; and

FIGS. 26A-26C are schematic views illustrating a cable winding operation.

### DETAILED DESCRIPTION OF THE EMBODIMENTS

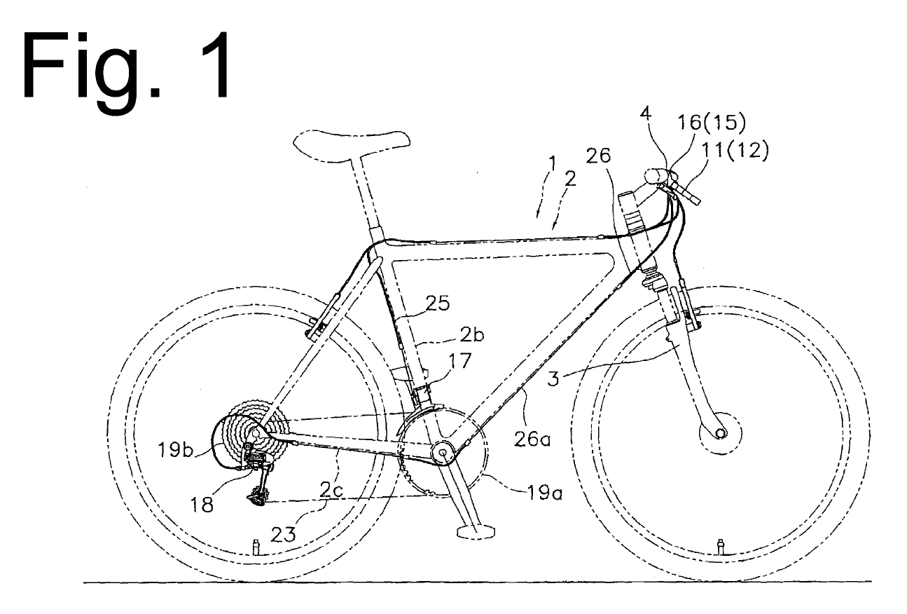

FIG. 1 is a side view of a bicycle 1 that includes particular embodiments of transmission shift control devices. Bicycle 1 is a sport bicycle of a mountain bike type, and it comprises a frame 2, a front suspension fork 3 rotatably mounted to frame 2, a handlebar assembly 4 mounted to the upper part of fork 3, a front derailleur 17 mounted to a middle portion of frame 2, and a rear derailleur 18 is mounted to a rear end of frame 2. Front derailleur 17 is placed, for example, at a lower portion of a seat tube 2b of frame 2 for guiding a chain 23 among a plurality of (e.g., three) front sprockets 19a. Rear derailleur 18 is placed at the rear of a chain stay 2c of frame 2 for guiding chain 23 among a plurality of (e.g., nine) rear sprockets 19b. Front derailleur 17 is connected to a front shift control device 15 through a front shift control cable 25, and rear derailleur 18 is connected to a rear shift control device 16 through a rear shift control cable 26 that includes an inner cable 26a. Front and rear shift control devices 15 and 16 are mounted at opposite ends of handlebar 4 laterally inwardly from front and rear brake levers 12 and 11, respectively, and they are constructed symmetrically while accommodating different numbers of sprockets. Thus, only the structure and operation of rear shift control device 16 will be described in detail.

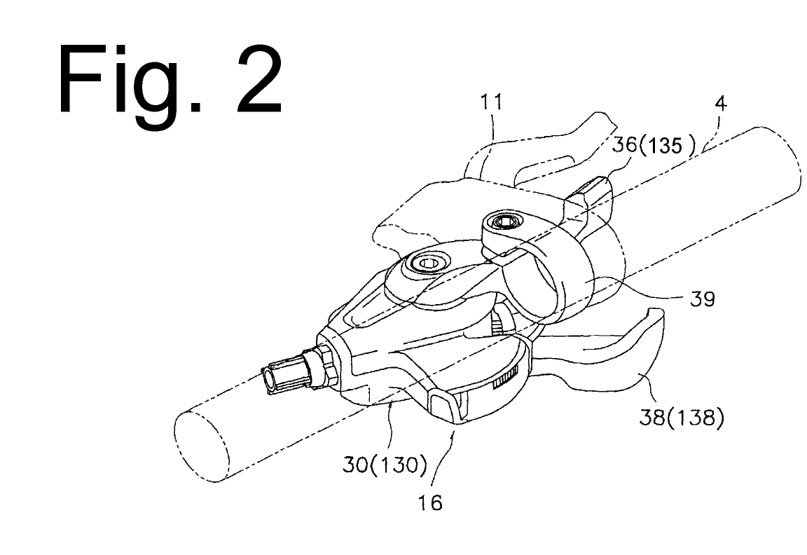

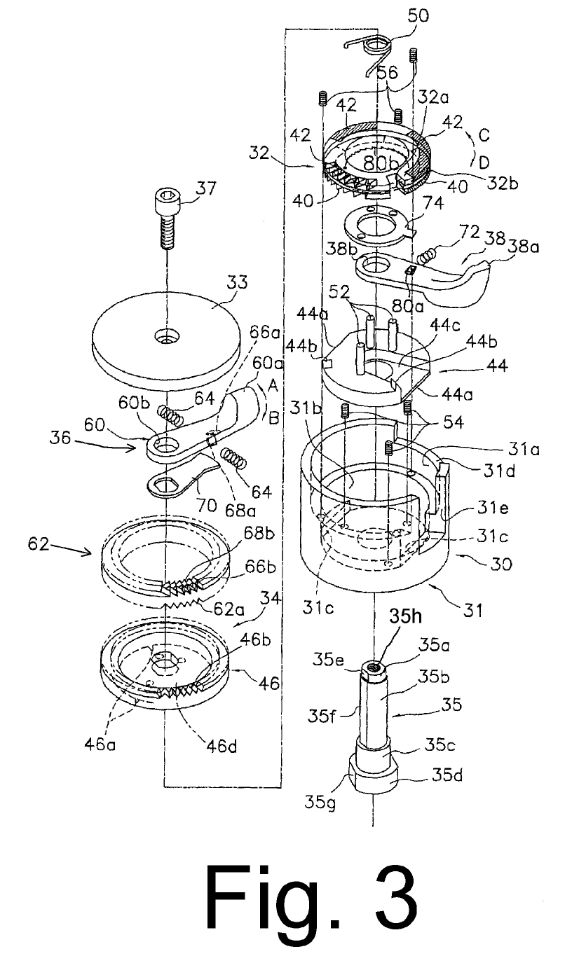

As shown in FIG. 2, rear shift control device 16 comprises a mounting member 30 structured to be mounted to handlebar 4 through a mounting band 39. If desired, mounting member 30 may be integrally secured to a mounting bracket for rear brake lever 12. As shown in FIG. 3, rear shift control device 16 further comprises a support shaft 35 that mounts to a closed-end cylindrical body portion 31 of mounting member 30, a cable coupling member in the form of a winding member 32 rotatably mounted to support shaft 35 for rotating in a cable pulling direction (indicated by arrow C) and a cable releasing direction (indicated by arrow D) of inner cable 26a, a positioning member 44 disposed between winding member 32 and the bottom of body portion 31 for selectively holding winding member 32 in any one of a plurality of operating positions corresponding to a plurality of shift positions of rear derailleur 18, a first operating member in the form of a release lever 36 for a cable releasing operation, a second operating member in the form of a winding lever 38 for a cable winding operation, an intermediate member 62, a release member 46 disposed between intermediate member 62 and winding member 32, a disc-shaped cover member 33, and a screw 37 that screws into a threaded opening 35h in a top portion of support shaft 35 for fastening cover member 33 to the top of body portion 31 and retaining all of the noted components within body portion 31.

Body portion 31 defines two coaxial cylindrical large and small accommodation spaces 31a and 31b therein, wherein a pair of parallel rotation inhibiting flats 31c are formed at the bottom of small accommodation space 31b. Body portion 31 also includes notches 31d and 31e, wherein notch 31d receives release lever 36 therethrough and limits its range of motion, and notch 31e receives winding lever 38 therethrough and limits its range of motion.

Support shaft 35 is a stepped shaft having a small diameter portion 35a at the top, a middle diameter portion 35b, and a large diameter portion 35c at the bottom. A flange 35d is formed at the end of large diameter portion 35c. Parallel rotation inhibiting flats 35e, 35f and 35g are formed in small diameter portion 35a, middle diameter portion 35b and flange 35d, respectively. Rotation inhibiting flats 35g engage the bottom of body portion 31 to nonrotatably fix support shaft 35 relative to body portion 31.

Positioning member 44 is mounted in small accommodation space 31b of body portion 31. Positioning member 44 comprises a disk-shaped member having parallel rotation inhibiting flats 44a that engage rotation inhibiting flats 31c in body portion 31 to nonrotatably mount positioning member 44 relative to body portion 31. Three rod-shaped contact members 52 and three serrated positioning pawls 44b extend upwardly from the upper surface of positioning member 44. Positioning pawls 44b are placed at three evenly-spaced circumferential positions at the outer peripheral edge of positioning member 44. Three coil springs 54 are mounted between a bottom surface of positioning member 44 and a bottom surface of body portion 31 to bias positioning member 44 upwardly. A lever accommodating recess 44c is formed at the upper surface of positioning member 44 for receiving winding lever 38 therein and limiting its range of motion.

Winding member 32 comprises a ring-shaped metal member rotatably mounted around support shaft 35 within small accommodation space 31b above rotation inhibiting flats 31c. Winding member 32 includes, at an outer peripheral surface thereof, a cable coupling portion 32a that locks a cable nipple (not shown) secured to a tip of inner cable 26a, and a cable winding groove 32b for winding inner cable 26a. Winding member 32 is biased in the cable releasing direction by a biasing member in the form of a torsion coil spring 50. Spring 50 has one end fixed to winding member 32 and another end fixed to positioning member 44. A first winding member ratchet unit 40 is formed at an outer peripheral portion of a lower surface of winding member 32, a second winding member ratchet unit 80b is formed at an inner peripheral portion of a lower surface of winding member 32, and a third winding member ratchet unit 42 is formed at an upper surface of winding member 32. If desired, first and third winding member ratchet units 40 and 42 may be formed in three circumferential groups corresponding to the shaded portions indicated in FIG. 3. Second winding member ratchet unit 80b is formed over the entire inner peripheral portion of the lower surface of winding member 32.

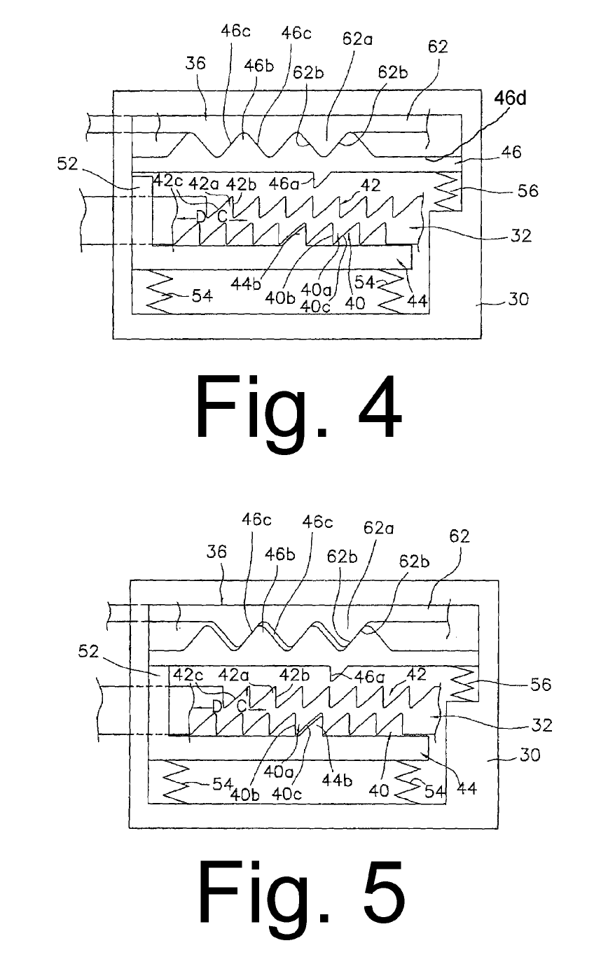

As schematically shown in FIG. 4, first and third winding member ratchet units 40 and 42 comprise a plurality of serrated ratchet teeth 40a and 42a. The numbers of ratchet teeth 40a and 42a are determined by the number of operating positions of winding member 32 (shift steps), and they are spaced accordingly. Each ratchet tooth 40a has a vertical surface 40b that faces to the left for contacting a right-facing vertical surface of a corresponding positioning pawl 44b of positioning member 44 for preventing rotation of winding member 32 in the cable releasing direction. Each ratchet tooth 40a also has an inclined surface 40c on its right side. First winding member ratchet unit 40 and positioning pawls 44b on positioning member 44 form a positioning unit that selectively maintains winding member 32 in selected ones of the plurality of operating positions. Each ratchet tooth 42a has a vertical surface 42b on its right side and an inclined surface 42c on its left side.

Release member 46 is a disk-shaped member nonrotatably mounted to rotation inhibiting flats 35f of support shaft 35 above winding member 32 in large accommodation space 31a of body portion 31 in a manner that allows vertical movement along support shaft 35. A bottom surface 46d of release member 46 engages contact members 52 on positioning member 44 so that both positioning member 44 and release member 52 are biased upwardly by springs 54 located below positioning member 44. Furthermore, biasing members in the form of coil springs 56 are disposed between bottom surface 46d of release member 46 and a stepped surface formed by body portion 31 at the transition between large accommodation space 31a and small accommodation space 31b to bias release member 52 upwardly. In operation, discussed below, release member 46 moves downward to release the engagement between first winding member ratchet unit 40 and positioning pawls 44b on positioning member 44.

Three serrated tooth engaging pawls 46a extend downwardly from the bottom surface 46d of release member 44, and a plurality of release member cam teeth 46b extend upwardly along an entire outer peripheral upper surface of release member 46. As shown in FIG. 4, each tooth engaging pawl 46a has a left-facing vertical surface adapted to contact a corresponding vertical surface 42b of a ratchet tooth 42a, and a height of tooth engaging pawl 46a is slightly less than the height of its corresponding ratchet tooth 42a. Each release member cam tooth 46b has a pair of side surfaces 46c that form the shape of a triangle.

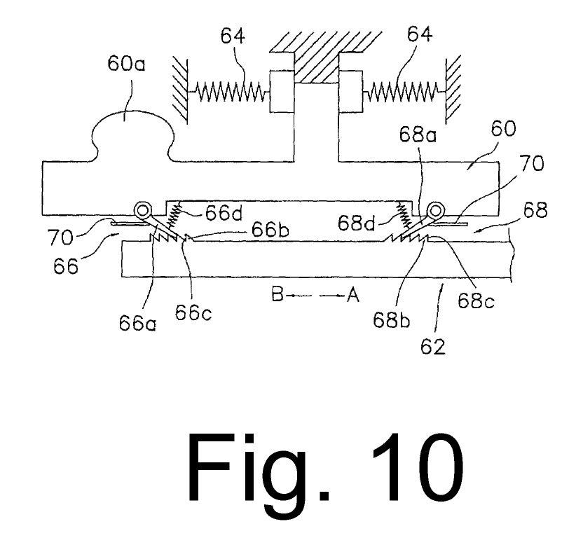

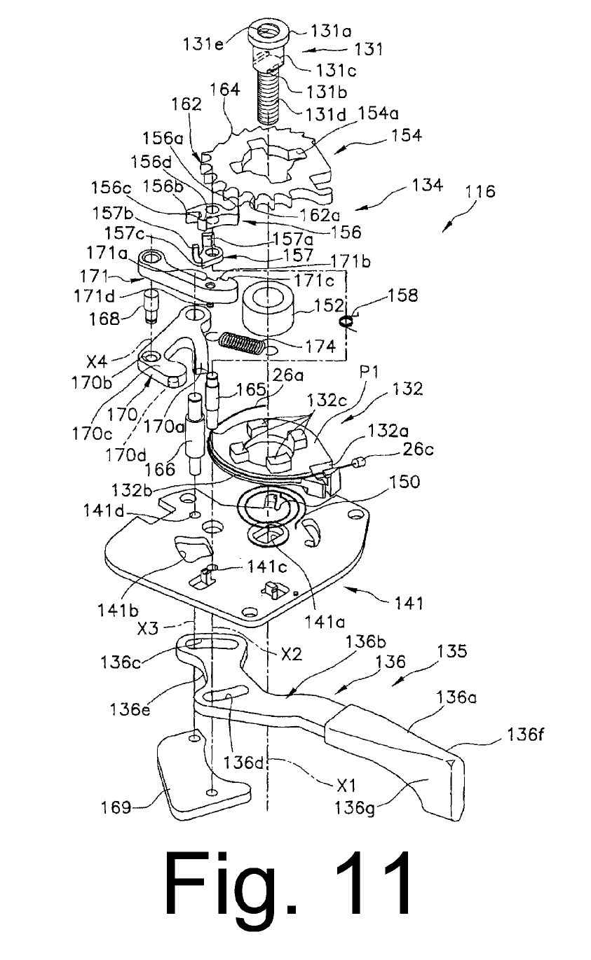

Intermediate member 62 is a ring-shaped member, and it is disposed between release member 46 and cover member 33. A plurality of intermediate member cam teeth 62a extend downwardly along an entire outer peripheral lower surface of intermediate member 62 for contacting release member cam teeth 46b, a plurality of serrated first intermediate member ratchet teeth 66b extend upwardly along an entire outer peripheral upper surface of intermediate member 62, and a plurality of serrated second intermediate member ratchet teeth 68b extend upwardly along an entire inner peripheral upper surface of intermediate member 62. As shown in FIG. 4, each intermediate member cam tooth 62a has a pair of side surfaces 62b that form the shape of a triangle. The engagement between intermediate member cam teeth 62a and release member cam teeth 46b allows intermediate member 62 to move release member 46 toward and away from intermediate member 62 when intermediate member 62 moves in either a clockwise or a counterclockwise direction. As shown in FIGS. 3 and 10, each first intermediate member ratchet tooth 66b has a clockwise-facing vertical surface 66c, and each second intermediate member ratchet tooth 68b has a clockwise-facing vertical surface 68c.

Release lever 36 includes a release lever body 60 with a mounting opening 60b mounted around support shaft 35 at the stepped surface between small diameter portion 35a and middle diameter portion 35b for rotation in a first direction (indicated by a counterclockwise arrow A in FIG. 3) and a second direction (indicated by a clockwise arrow B in FIG. 3). Release lever body 60 is biased to a start or neutral position by a pair of biasing members in the form of coil springs 64 placed on opposite sides thereof. A positioning member (not shown) for positioning release lever body 60 in the neutral position is placed between release lever body 60 and small diameter portion 35a of support shaft 35. The positioning member may comprise, for example, a spring-biased radially-movable positioning pin mounted to small diameter portion 35a for engaging a positioning recess (detent) formed in an inner peripheral surface of mounting opening 60b. Release lever body 60 extends radially outwardly from body portion 31 and includes an operating tab 60a structured to be manipulated by the rider's hand (e.g., by a finger or thumb). Release lever 36 is operated by rotating release lever 36 either clockwise or counterclockwise from the start position to a finish position determined by the sides of notch 31d in body portion 31.

As shown in FIGS. 3 and 10, a first pawl 66a is pivotably mounted to the lower surface of release lever body 60 and biased toward engagement with the plurality of first intermediate member ratchet teeth 66b by a biasing member in the form of a coil spring 66d, and a second pawl 68a is pivotably mounted to the lower surface of release lever body 60, radially inwardly from first pawl 66a, and biased toward engagement with the plurality of second intermediate member ratchet teeth 68b by a biasing member in the form of a coil spring 68d. First pawl 66a, coil spring 66d and the plurality of first intermediate member ratchet teeth 66b form a first one-way clutch 66 for transmitting only counterclockwise rotation of release lever 36 to intermediate member 62, and second pawl 68a, coil spring 68d and the plurality of second intermediate member ratchet teeth 68b form a second one-way clutch 68 for transmitting only clockwise rotation of release lever 36 to intermediate member 62. A pawl control plate 70 is nonrotatably mounted to support shaft 35 to ensure that only one of the one-way clutches 66 or 68 operate at a particular time. For example, when release lever 36 is rotated clockwise (in the direction B), then first pawl 66a of first one-way clutch 66 is pressed upwardly by pawl control plate 70 to prevent first pawl 66a from engaging any of the plurality of first intermediate member ratchet teeth 66b so that only second pawl 68a is allowed to engage the plurality of second intermediate member ratchet teeth 68b and thereby transmit rotation of release lever 36 to intermediate member 62 in the clockwise direction. Similarly, when release lever 36 is rotated counterclockwise (in the direction A), then second pawl 68a of second one-way clutch 68 is pressed upwardly by pawl control plate 70 to prevent second pawl 68a from engaging any of the plurality of second intermediate member ratchet teeth 68b so that only first pawl 66a is allowed to engage the plurality of first intermediate member ratchet teeth 66b and thereby transmit rotation of release lever 36 to intermediate member 62 in the counterclockwise direction.

Winding lever 38 includes a mounting opening 38b rotatably mounted around support shaft 35 at the stepped surface between middle diameter portion 35b and large diameter portion 35c. As noted above, winding lever 38 is fitted within a notch 31e of body portion 31 and within lever accommodating recess 44c of positioning member 44 between positioning member 44 and winding member 32 so that notch 31e and lever accommodating recess 44c limit a range of motion of winding lever 38. A biasing member in the form of a coil spring 72 is placed on the counterclockwise side of winding lever 38 to bias winding lever 38 clockwise to a start position. Winding lever 38 extends radially outwardly from body portion 31 in a different direction from release lever 36 and includes an operating tab 38a structured to be manipulated by the rider's hand (e.g., by a finger or thumb). Winding lever 38 is operated by rotating winding lever 38 counterclockwise from the start position determined by the clockwise side of notch 31e to a finish position determined by the counterclockwise side of notch 31e.

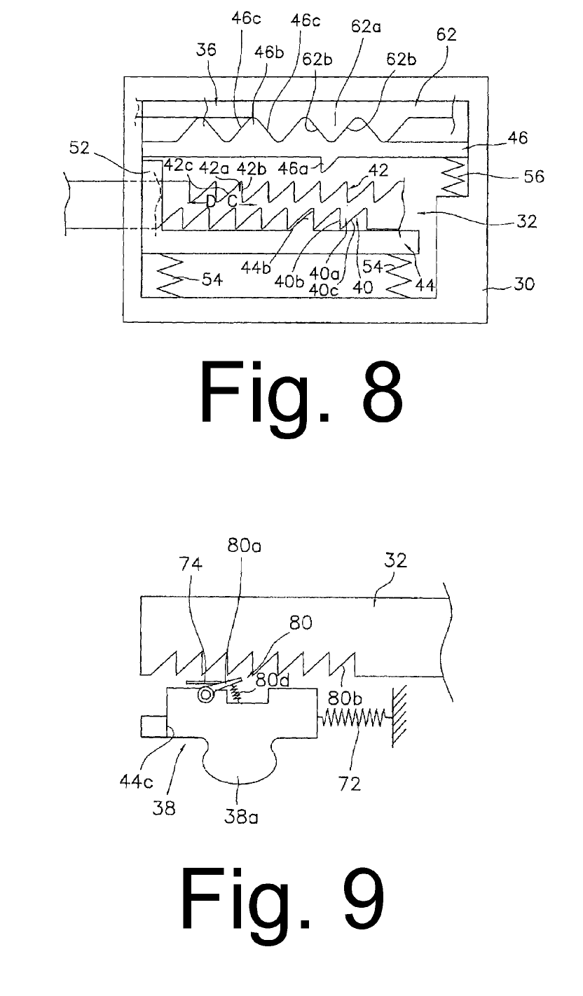

As shown in FIGS. 3 and 9, a winding lever pawl 80a is pivotably mounted to the upper surface of winding lever 38 and biased toward engagement with second winding member ratchet unit 80b by a biasing member in the form of a coil spring 80d. Winding lever pawl 80a, coil spring 80d and second winding lever ratchet unit 80b form a one-way clutch 80 for transmitting only counterclockwise rotation of winding lever 38 to winding member 32. A pawl control plate 74 is nonrotatably mounted to contact members 52 on positioning member 44 to keep winding lever pawl 80a out of engagement with second winding member ratchet unit 80b when winding lever 38 is in the start position.

Rotating winding lever 38 counterclockwise in FIG. 3 (to the right in FIG. 9) from the start position to the finish position operates winding member 32 in the cable pulling direction. More specifically, when winding lever 38 leaves the winding member start position, winding lever pawl 80a moves off of pawl control plate 74 engages one of the plurality of ratchet teeth forming second winding member ratchet unit 80b. Thereafter, winding member 32 rotates together with winding lever 38 in the cable pulling direction. At the same time, the inclined surfaces of positioning teeth 44b slide relative to the inclined surfaces 40c of their adjacent ratchet teeth 40a, and positioning member 44 is pushed downwardly against the biasing force of springs 54 until positioning teeth 44b move over the tips of their corresponding ratchet teeth 40a and are located in the next space between adjacent ratchet teeth 40a. Them, winding member 32 is located in a destination operating position corresponding to a destination rear sprocket 19b. If desired, the rider may continue pressing winding lever 38 counterclockwise, in which case winding member 32 will rotate to a plurality of destination operating positions.

Rotating release lever 36 either clockwise or counterclockwise operates winding member 32 in the cable releasing direction. For example, when the rider presses release lever 36 counterclockwise with his or her thumb, then first pawl 66a of first one-way clutch 66 engages one of the plurality of first intermediate member ratchet teeth 66b, thus rotating intermediate member 62 counterclockwise together with release lever 36. When the rider presses release lever 36 clockwise with his or her index finger, then second pawl 68a of second one-way clutch 68 engages one of the plurality of second intermediate member ratchet teeth 68b, thus rotating intermediate member 62 clockwise together with release lever 36. In either case, side surfaces 62b of intermediate member cam teeth 62a slide against side surfaces 46c of release member cam teeth 46b, thus pushing release member 46 downwardly against the biasing force of springs 56 away from intermediate member 62. FIGS. 5-8 show the operation of rear shift control device 16 when release lever 36 is rotated counterclockwise (intermediate member 62 moves to the right in FIGS. 5-8).

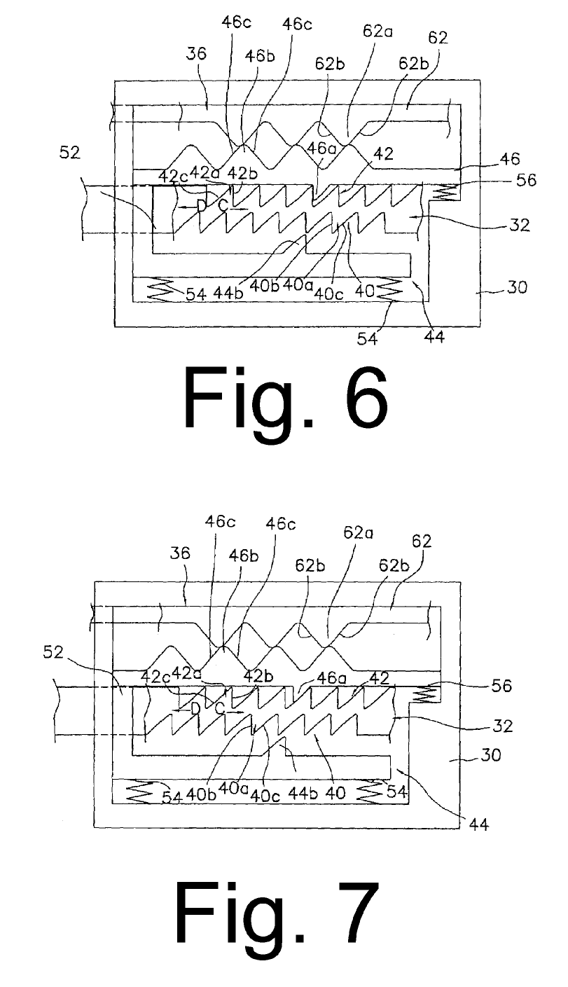

When release member 46 moves downward this movement is communicated to positioning member 44 through contact members 52, thereby also moving positioning member 44 downwardly against the biasing force of springs 54 as shown in FIG. 5. Eventually, positioning pawls 44b on positioning member 44 disengage from ratchet teeth 40a on winding member 32 (before intermediate member cam teeth 62a and release member cam teeth 46b reach their respective apexes), and winding member 32 rotates clockwise (to the left in FIG. 6) in the cable unwinding direction D in accordance with the biasing force of spring 50. As winding member 32 continues rotating clockwise, the inclined surfaces of tooth engaging pawls 46a on release member 46 engage corresponding inclined surfaces 42c of corresponding ratchet teeth 42a on winding member 32 as shown in FIG. 7, thereby stopping rotation of winding member 32.

If the rider removes his or her hand from release lever 36 at this point, springs 56 push release member 46 upwardly, and coil springs 54 push positioning member 44 upwardly, thereby disengaging tooth engaging pawls 46a on release member 46 from ratchet teeth 42a on winding member 32. Winding member 32 then continues rotating in the cable unwinding direction D until positioning pawls 44b on positioning member 44 reengage with corresponding ratchet teeth 40a on winding member 32 as shown in FIG. 8 to set winding member 32 in a destination operating position corresponding to a desired rear sprocket 19b. Alternatively, the rider may continue pressing release lever 36, in which case the process repeats itself and winding member 32 rotates to a plurality of further destination operating positions.

While the operation of release lever 36 in either the clockwise or counterclockwise direction caused winding member 32 to rotate in the cable releasing direction in this embodiment, the winding direction of inner cable 26a may be reversed in FIG. 3, in which case release lever 36 becomes the winding lever, the winding lever 38 becomes the release lever, and cable pulling may be accomplished by rotating lever 36 either clockwise or counterclockwise. In this case, when rear derailleur 18 exerts a biasing force on inner cable 26a, the biasing force of coil spring 50 needs to be higher than that of the biasing force created by the derailleur.

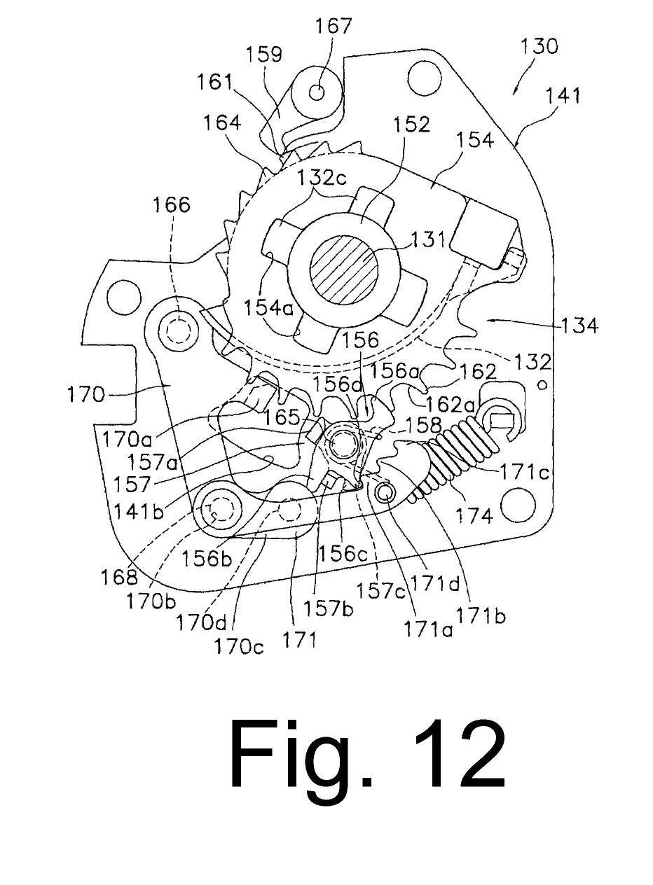

In the above embodiment, the various components that perform the positioning and releasing operation moved perpendicular to the plane of rotation of winding member 32. FIG. 11 is an exploded view of a second embodiment of a rear shift control device 116 wherein the various components that perform the positioning and releasing operation move parallel to a plane P1 of rotation of a winding member 132. Shift control device 116 includes a mounting member 130 (FIG. 2) having generally the same outer shape as mounting member 30 in the first embodiment. Another mounting member in the form of a mounting bracket 141 is mounted within an interior space of mounting member 130 in a convenient manner. Mounting member 130 may be formed from a synthetic resin, and mounting bracket 141 may be formed from metal, for example. A support shaft 131 is connected to mounting member 130 and extends in a direction of a first axis X1. More specifically, support shaft 131 includes a circular head 131a with a threaded opening 131e, a rotation support portion 131c, a pair of parallel rotation inhibiting flats 131b formed at the lower end of rotation support portion 131c for nonrotatably engaging a corresponding pair of rotation inhibiting flats formed by a slot-shaped opening 141a in mounting bracket 141, and a threaded portion 131d disposed below rotation support portion 131c. A bolt (not shown) is screwed into threaded opening 131e through mounting member 130 to secure support shaft 131 to mounting member 130.

Winding member 132 is mounted to support shaft 131 through a bushing 152 for rotation around first axis X1 in a cable pulling (winding) direction and a cable releasing (unwinding) direction of inner cable 26a. A positioning member 154 has a plurality of recesses 154a that engage a corresponding plurality of projections 132c formed in winding member 132 so that winding member 132 and positioning member 154 rotate as a unit. One of the four projections 132c has a circumferential length different from the others so that the rotational phases of positioning member 154 and winding member 132 may be reliably matched. An intermediate member 170 is rotatably supported to an upper portion of a pivot shaft 166 that has a lower portion extending through an opening 141d in mounting bracket 141, and a release member 171 is rotatably mounted to a pivot shaft 168 attached to intermediate member 170. A positioning member in the form of a positioning pawl 156 and a tooth engaging member in the form of a tooth engaging pawl 157 both are rotatably mounted to an upper portion of a pivot shaft 165 that has a lower portion extending through an opening 141c in mounting bracket 141. As a result, positioning pawl 156 and tooth engaging pawl 157 rotate around an axis X2 that extends along pivot shaft 165, and intermediate member 170 rotates around an axis X3 that extends along pivot shaft 166. In this embodiment, axes X1, X2 and X3 are spaced apart parallel to each other. The lower portions of pivot shafts 165 and 166 extend through guides in the form of arcuate slots 136d and 136c, respectively, formed in a release lever body 136 of a release lever 135 and are fastened to a support plate 169. As with release lever 36 in the first embodiment, release lever 135 operates winding member 132 in the cable releasing direction when release lever 135 is rotated in either a clockwise or a counterclockwise direction. A winding lever 138 (FIG. 2) operates winding member 132 in the cable pulling direction.

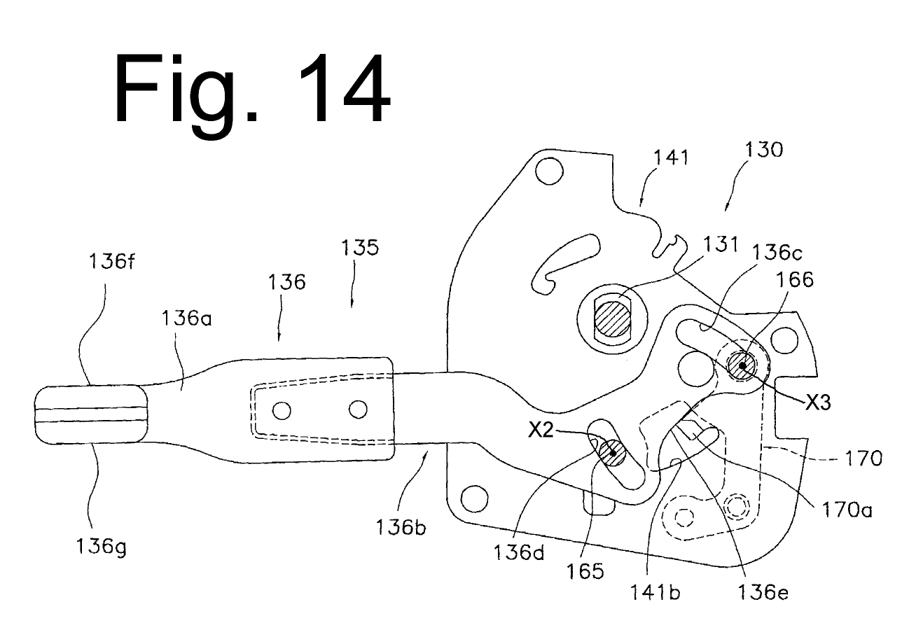

Release lever body 136 disposed at the lower surface of mounting bracket 141. Release lever body 136 comprises an operating tab 136a and a radially inner body 136b. Operating tab 136a may be formed from synthetic resin, die cast metal or the like, and it includes operating surfaces 136f and 136g structured to be contacted by the rider's hand (e.g., by a finger or thumb). Radially inner body 136b may be formed from metal such as stainless steel alloys or steel, and it is slightly bent in the middle so as to be placed around support shaft 131. Radially inner body 136b includes arcuate slots 136c, 136d and a control surface 136e that function in a manner described below. As shown in FIG. 13, slot 136c has an arcuate shape centered on the lower end of slot 136d, and slot 136d has an arcuate shape centered on the lower end of slot 136c.

Winding member 132 may comprise a ring-shaped member formed from a synthetic resin such as a polyacetal resin. Winding member 132 includes, at an outer peripheral surface thereof, a cable coupling portion 132a that locks a cable nipple 26c secured to a tip of inner cable 26a, and a cable winding groove 132b for winding inner cable 26a. A biasing member in the form of a torsion coil spring 150 biases winding member 132 in a cable releasing direction. Spring 150 has one end fixed to winding member 132 and another end fixed to mounting bracket 141.

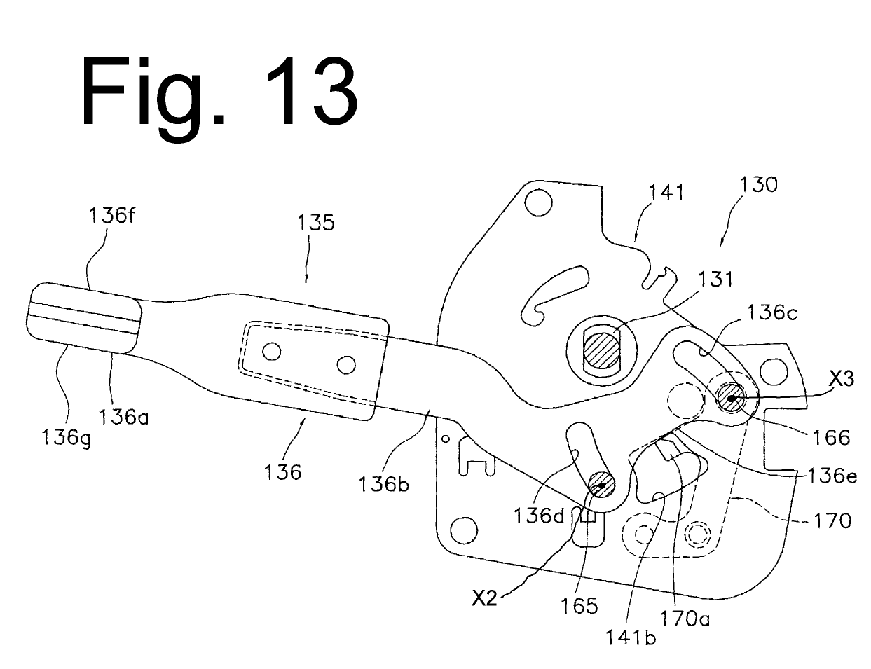

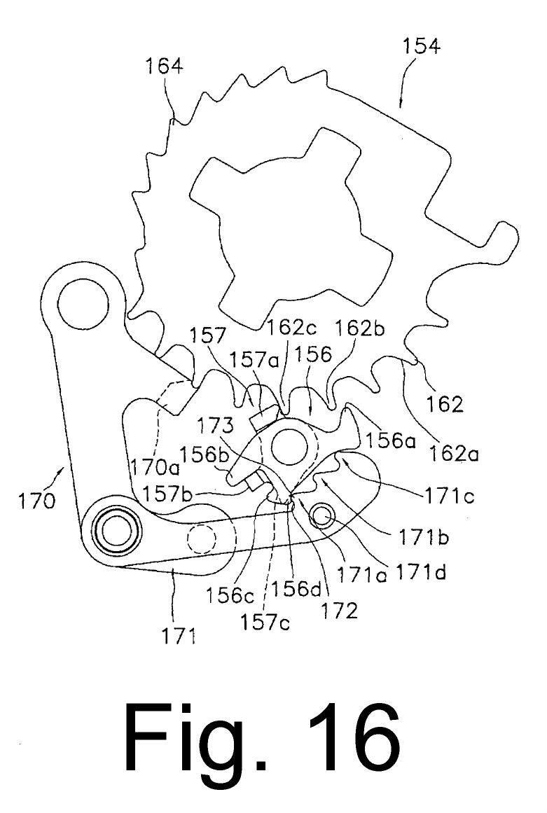

Positioning member 154 may include, for example, nine radially extending positioning teeth 162 and eight radially extending drive teeth 164 corresponding to the number of shift positions of rear derailleur 18, and they are spaced accordingly. Positioning pawl 156 rotates between an engaged position, shown in FIG. 12, for engaging positioning teeth 162, and a disengaged position, shown in FIG. 16, for disengaging from positioning teeth 162. Positioning pawl 156 is biased counterclockwise in FIG. 11 toward the engaged position by a biasing member in the form of a torsion coil spring 158. Positioning member 154 and positioning pawl 156 form a positioning unit 134 for maintaining winding member 132 in selected ones of a plurality of operating positions. Tooth engaging pawl 157 rotates between an engaged position, shown in FIG. 16, for engaging positioning teeth 162, and a disengaged position, shown in FIG. 12, for disengaging from positioning teeth 162.

Positioning pawl 156 includes a positioning pawl portion 156a that contacts an engagement surface 162a of positioning teeth 162 to prevent winding member 132 and positioning member 154 from rotating in the cable releasing direction, a pair of regulating protrusions 156b and 156c circumferentially spaced apart from each other for controlling the motion of tooth engaging pawl 157 and for being controlled by the motion of tooth engaging pawl 157, and a control protrusion 156d that engages release member 171. Control protrusion 156d slightly protrudes toward release member 171. These components function in a manner discussed below.

Tooth engaging pawl 157 is rotatably mounted to pivot shaft 165 below positioning pawl 156. Tooth engaging pawl 157 comprises a tooth engaging pawl portion 157a that is bent upward from below positioning pawl 156 in FIG. 11 for engaging selected ones of the plurality of positioning teeth 162, a regulating portion 157b bent upward so as to be placed between the pair of regulating protrusions 156b and 156c of positioning pawl 156 so that tooth engaging pawl 157 rotates within a predetermined range (for example, within a range of 5 to 10 degrees) relative to positioning pawl 156, and a release cam portion 157c. As shown in FIG. 16, regulating protrusion 156c of positioning pawl 156 overlaps release cam portion 157c of tooth engaging pawl 157 and hides release cam portion 157c when regulating protrusion 156b contacts regulating portion 157b. These components function in a manner described below.

As shown in FIGS. 11 and 12, intermediate member 170 comprises a lever engaging portion 170a, a connecting portion 170b, an upper support portion 170c, and a lower support portion 170d. Lever engaging portion 170a bends downwardly and extends thorough an opening 141b in mounting plate 141 for engaging control surface 136e of release lever 135. Connecting portion 170b mounts pivot shaft 168 for rotatably supporting release member 171. Upper support portion 170c provides a supporting surface for release member 171 to prevent rattling during relative movement between intermediate member 170 and release member 171, and lower support portion 170d contacts the upper surface of mounting plate 141 to prevent rattling during relative movement between intermediate member 170 and mounting plate 141.

Release member 171 includes a plurality of (e.g., three) release portions 171a-171c at a tip thereof, and a spring mounting portion 171d. The three release portions 171a-171c are provided so that three shift operations may be performed during a single movement of release lever 135 from a start position to a finish position. For example, rear derailleur 18 can be moved from ninth gear to sixth gear with a single stroke of release lever 135.

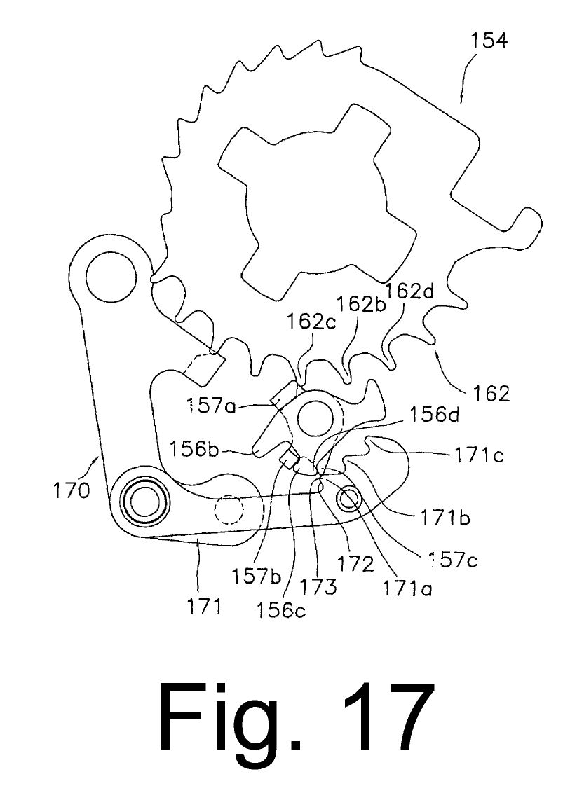

As shown in FIG. 17, each of the release portions 171a-171c includes a first control portion 172 and a directly adjacent second control portion 173. As discussed below, first control portion 172 engages control protrusion 156d of positioning pawl 156 to release the engagement between positioning pawl 156 and one of the plurality of positioning teeth 162 on positioning member 154, and second control portion 173 is driven by release cam portion 157c of tooth engaging pawl 157 to allow positioning pawl 156 to engage another one of the plurality of positioning teeth 162 on positioning member 154.

Spring mounting portion 171d is connected to one end of a biasing member in the form of a coil spring 174. The other end of coil spring 174 is connected to mounting bracket 141. Coil spring 174 biases release member 171 counterclockwise and radially inwardly toward support shaft 131. Since release member 171 is mounted to intermediate member 170 through pivot shaft 168, coil spring 174 also biases intermediate member 170 counterclockwise and radially inwardly toward support shaft 131 such that lever engaging portion 170a of intermediate member 170 contacts control surface 136e of release lever 135, thus biasing release lever 135 toward support shaft 131 in the orientation shown in FIG. 13.

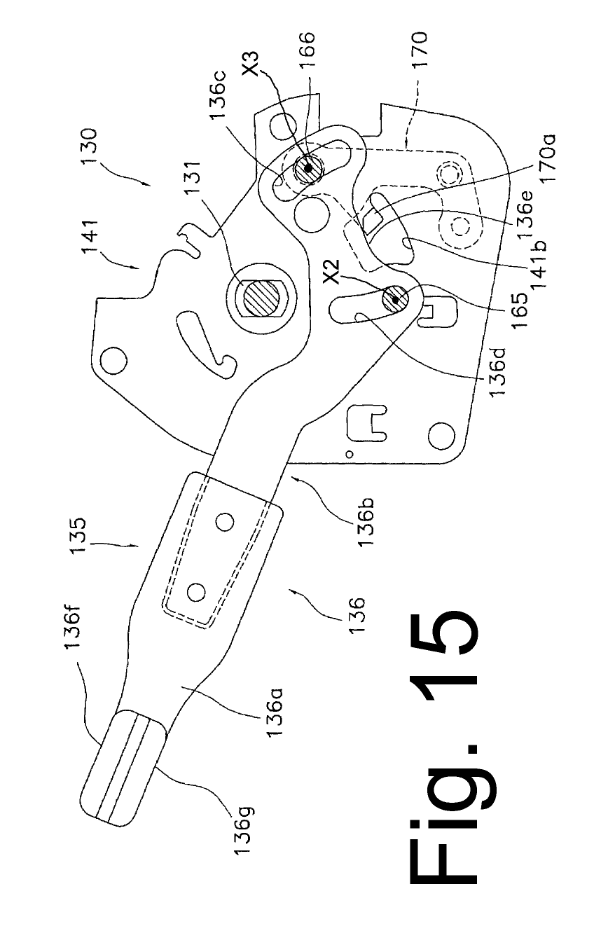

FIG. 13 shows release lever 135 in a neutral position as a result of the biasing force of coil spring 174 transmitted through release member 171 and intermediate member 170. In this position, pivot shafts 165 and 166 are located at the lower ends of slots 136d and 136c, respectively. Since the biasing force of coil spring 174 is applied to control surface 136e of release lever 135 via lever engaging portion 170a of intermediate member 170, release lever 135 rotates centered around pivot shaft 166 and axis X3 as shown in FIG. 14 when the rider presses operating surface 136f to rotate release lever 135 counterclockwise. On the other hand, release lever 135 rotates centered around pivot shaft 165 and axis X2 as shown in FIG. 15 when the rider presses operating surface 136g to rotate release lever 135 clockwise. In both cases, control surface 136e always is in contact with lever engaging portion 170a, and control surface 136e causes lever engaging portion 170a to move diagonally downward to the right in FIG. 13, thereby rotating intermediate member 170 and release member 171 clockwise in FIG. 11. As a result, winding member 132 is rotated in the cable releasing direction when release lever 135 is rotated in either the clockwise or the counterclockwise direction shown in FIG. 13.

Since the components activated by release lever 135 are not disposed on support shaft 131 in addition to winding member 132 and positioning member 154, the axial length of support shaft 131 may be reduced, thereby reducing the axial thickness of rear shift control device 116. While a single spring 174 biases release lever 136, intermediate member 170, and release member 171 in this embodiment, a separate biasing member may be provided for biasing each member.

Though not shown in FIG. 11, winding lever 138 is mounted to support shaft 131 above positioning member 154 for rotation from a start position to a finish position. A drive pawl 159 (FIG. 12) is rotatably mounted to winding lever 138 through a pivot shaft 167, and a biasing member such as a torsion coil spring (not shown) biases drive pawl 159 toward engagement with the plurality of drive teeth 164. However, drive pawl 159 is maintained in a disengaged position when winding lever 138 is located in the start position by a pawl control plate 161 mounted to mounting bracket 141 in a known manner. A biasing member (not shown) biases winding lever 138 toward the operation start position (clockwise in FIG. 12) in any known manner.

When the rider rotates winding lever 138 from the start position toward the finish position, drive pawl 159 moves off of the end of pawl control plate 161 and engages one of the plurality of drive teeth 164 to rotate winding member 132 in the cable pulling direction (counterclockwise in FIG. 12). At that time, the positioning tooth 162 adjacent to the positioning tooth 162 previously engaged by positioning pawl portion 156a of positioning pawl 156 contacts positioning pawl portion 156a, rotates positioning pawl 156 clockwise, and passes by positioning pawl portion 156a. After the positioning tooth 162 passes by positioning pawl portion 156a, positioning pawl 156 rotates counterclockwise to the engaged position. If the rider releases winding lever 138 at this time, then winding member 132 and positioning member 154 rotate slightly clockwise, and positioning pawl portion 156a abuts against the adjacent positioning tooth 162 to maintain winding member 132 in the new destination operating position. If desired, the rider may continue rotating winding lever 138, in which case winding member 132 rotates through multiple operating positions to a destination operating position determined by when the rider releases winding lever 138.

As noted above, the rider causes winding member 132 to rotate in the cable releasing direction by rotating release lever 135 either clockwise or counterclockwise from the start (neutral) position shown in FIG. 13, thereby causing control surface 136e of release lever 135 to move lever engaging portion 170a of intermediate member 170 diagonally downward to the right in FIG. 13, thereby rotating intermediate member 170 and release member 171 clockwise in FIG. 11 (counterclockwise in FIG. 13). As shown in FIG. 16, when intermediate member 170 rotates clockwise, it pulls release lever 171 to the left. This causes first control portion 172 of release portion 171a of release member 171 to engage control protrusion 156d of positioning pawl 156 to rotate positioning pawl 156 clockwise around pivot shaft 165 from the engaged position shown in FIG. 12 to the release position shown in FIG. 16. At the same time, first control portion 172 of release portion 171a of release member 171 also contacts release cam portion 157c of tooth engaging pawl 157 to cause tooth engaging pawl 157 to rotate clockwise so that tooth engaging pawl portion 157a moves from the disengaged position shown in FIG. 12 to the engaged position shown in FIG. 16.

When positioning pawl portion 156a of positioning pawl 156 disengages from its previously engaged positioning tooth 162, i.e., positioning tooth 162b in FIG. 16, positioning member 154 and winding member 132 rotate clockwise in the cable releasing direction in accordance with the biasing force of spring 150 until positioning tooth 162c presses against tooth engaging pawl portion 157a of tooth engaging pawl 157. Since tooth engaging pawl 157 can rotate relative to positioning pawl 156, positioning tooth 162c causes tooth engaging pawl 157 to rotate counterclockwise so that regulating portion 157b of tooth engaging pawl 157 moves from contacting regulating protrusion 156b of positioning pawl 156 to contacting regulating protrusion 156c of positioning pawl 156.

Then, as shown in FIG. 17, release cam portion 157c of tooth engaging pawl 157 presses against second control portion 173 of release portion 171a of release member 171 to disengage control protrusion 156d of positioning pawl 156 from first control portion 172 of release portion 171a. At that time, tooth engaging pawl 157 and positioning pawl 156 rotate counterclockwise together, and positioning pawl portion 156a of positioning pawl 156 moves toward the space between positioning teeth 162b and 162d on positioning member 154.

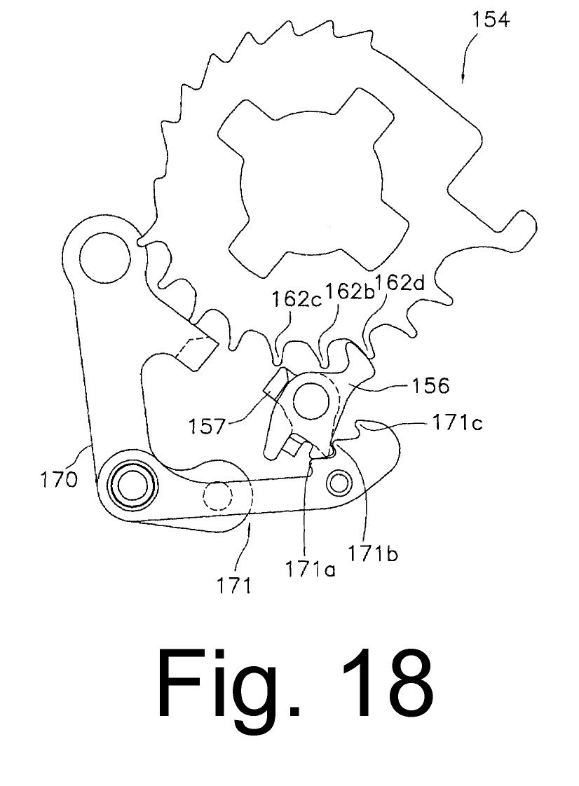

As tooth engaging pawl 157 and positioning pawl 156 continue to rotate together as a result of the force from positioning tooth 162c, tooth engaging pawl portion 157a disengages from positioning tooth 162c, and positioning member 154 continues rotating until positioning pawl portion 156a of positioning pawl 156 contacts positioning tooth 162d as shown in FIG. 18, thereby stopping rotation of positioning member 154 and winding member 132 at a destination operating position. At the same time, first control portion 172 of release portion 171b contacts release cam portion 157c of release member 157, thereby rotating release member 157 clockwise relative to positioning pawl 156 until regulating portion 157b of tooth engaging pawl 157 contacts regulating protrusion 156b of positioning pawl 156 and control protrusion 156d contacts release portion 171b of release member 171.

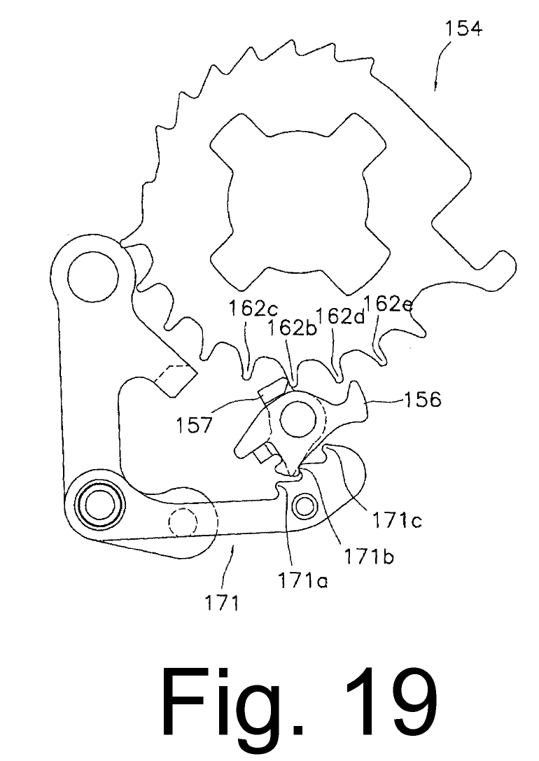

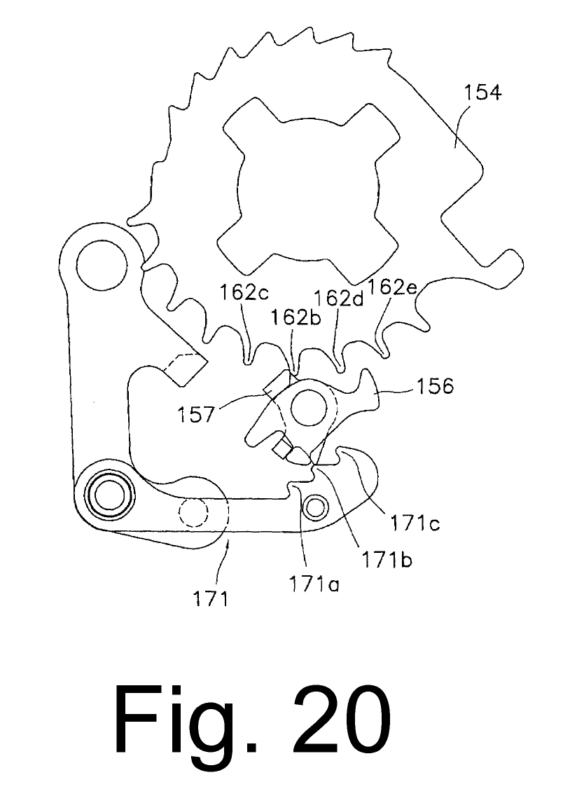

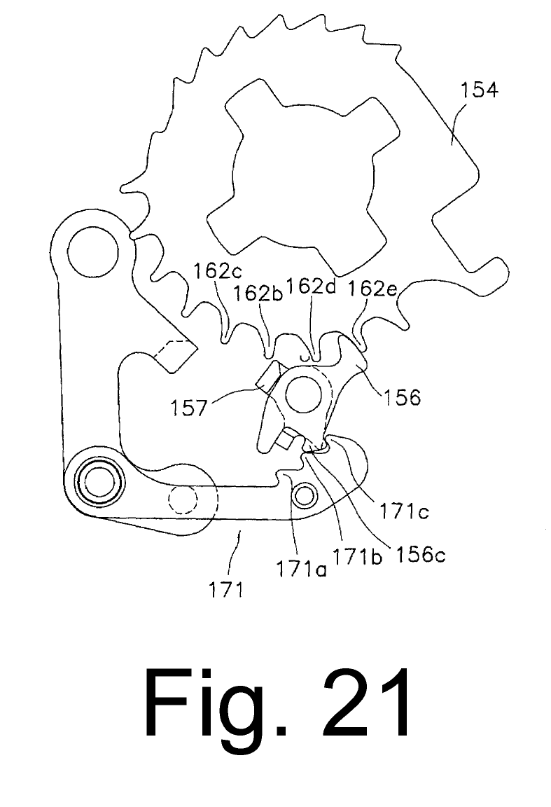

If the rider continues to rotate release lever 135 as shown in FIGS. 19 and 20, the process essentially repeats itself. This time, release portion 171b of release member 171 causes positioning pawl 156 to disengage from positioning tooth 162d as shown in FIG. 19, and positioning tooth 162b causes tooth engaging pawl 157 to rotate counterclockwise as shown in FIG. 20 to force positioning pawl 156 back into engagement with a following positioning tooth 162e as shown in FIG. 21. In this position, control protrusion 156d of positioning pawl 156 contacts release portion 171c of release member 171.

When the rider releases release lever 135 to finish the releasing operation, the biasing force of spring 174 pulls release member 171, intermediate member 170 and release lever 135 back to the position shown in FIG. 12. During this time, the one or more release portions 171a or 171b of release member 171 involved in the release operation merely skip over control protrusion 156d of positioning pawl 156 and release cam portion 157c of release member 157 because of the inclined rear surfaces of these components.

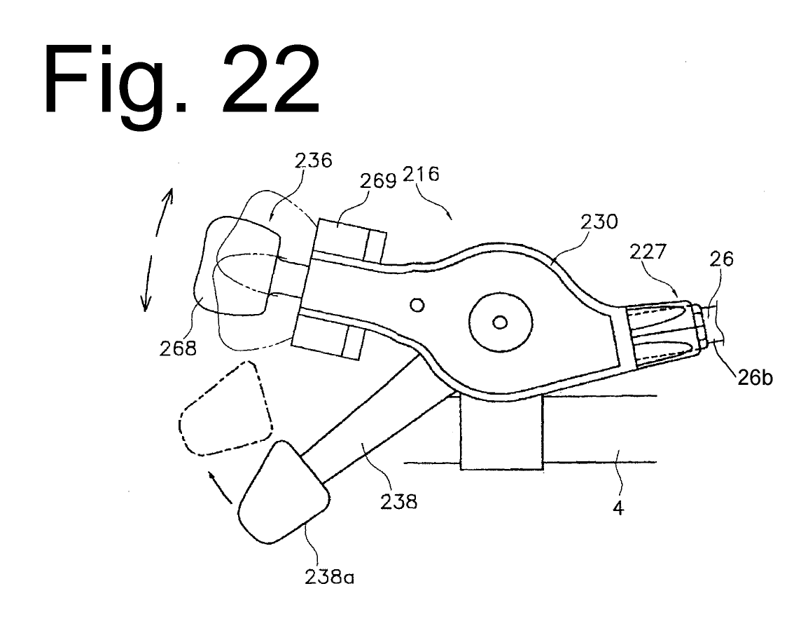

FIG. 22 is a plan view of another embodiment of a rear shift control device 216, and FIG. 23 is an exploded view of rear shift control device 216. In the second embodiment, release lever 135 rotated in a plane parallel to the first plane (P1), but in this embodiment a joystick-type release lever 236 is used. In this embodiment, rear shift control device 216 comprises a mounting member including a bracket 240 that may be formed from a metal plate configured to mount to handlebar 4 by a fastening bolt, a first cover 242 mounted to the lower side of bracket 240, and a second cover 244 mounted to the upper side of bracket 240. Bracket 240 has a planar surface 240a defining an opening 240b through which a support shaft 246 passes. Bracket 240 also has a threaded opening 240c for threadingly receiving an outer casing terminating member 227 therein for terminating an outer casing 26b of a rear shift cable 26.

A winding member 232 is rotatably mounted around support shaft 246 via a bushing 252 between bracket 240 and second cover 244. Winding member 232 is rotates in a plane parallel to plane 240a of bracket 240 in cable pulling (winding) and releasing (unwinding) directions. Winding member 232 includes, at an outer peripheral surface thereof, a cable coupling portion 232a that locks a cable nipple (not shown) secured to a tip of inner cable 26a, and a cable winding groove 232b for winding inner cable 26a. A biasing member in the form of a torsion spring 250 biases winding member 232 in a cable releasing direction. Spring 250 has one end fixed to winding member 232 and another end fixed to mounting bracket 240. An engaging protrusion 232c is formed on the upper surface of winding member 232 for engaging a mounting opening 254 in a positioning member 254 so that winding member 232 and positioning member 254 rotate as a unit. In this embodiment, positioning member 254 has a plurality of, e.g., eight radially extending positioning teeth 262 and eight radially extending drive teeth 264 corresponding to the number of shift positions of rear derailleur 18, and they are spaced accordingly.

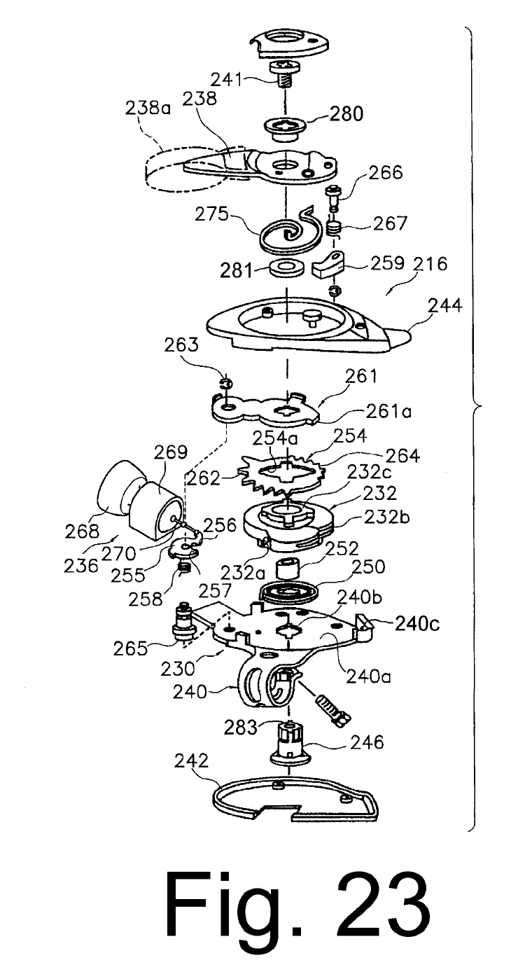

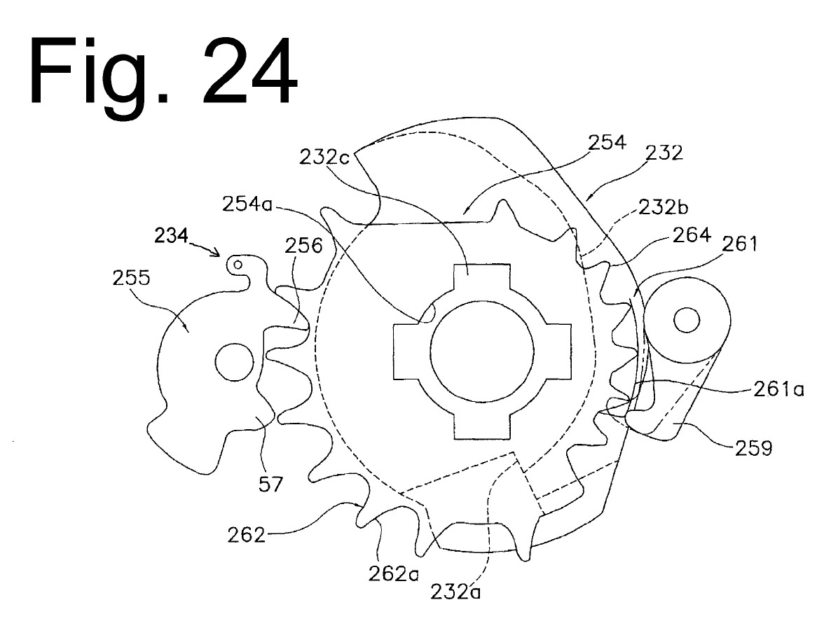

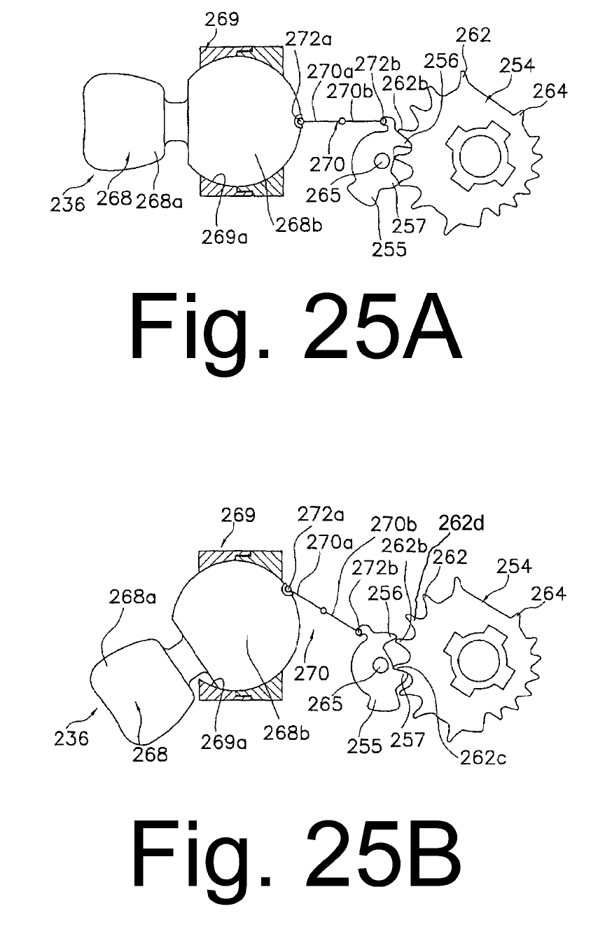

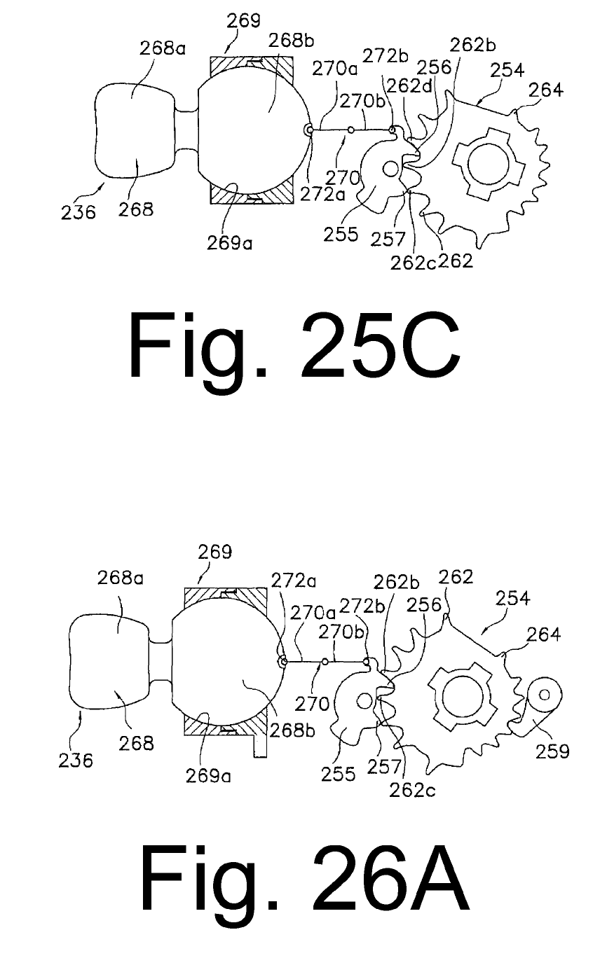

A pawl member 255 including a positioning pawl 256 and a tooth engaging pawl 257 formed together as one piece is pivotably mounted to a pivot shaft 265 attached to bracket 240 and to a pawl control plate 261. Pawl control plate 261 is nonrotatably mounted to support shaft 246, and the top of pivot shaft 265 is secured to pawl control plate 261 by a snap ring 263. Positioning pawl 256 rotates in a plane parallel to the rotation plane of winding member 232 between an engaged position shown in FIG. 25A for engaging one of the plurality of positioning teeth 262 (e.g., positioning tooth 262b), thereby preventing rotation of winding member 232 in the cable releasing direction and setting winding member 232 in one of a plurality of operating positions for rear derailleur 18, and a disengaged position shown in FIG. 25B for disengaging from the plurality of positioning teeth 262, thereby allowing rotation of winding member 232. Similarly, tooth engaging pawl 257 rotates in a plane parallel to the rotation plane of winding member 232 between an engaged position shown in FIG. 25B for engaging one of the plurality of positioning teeth 262 (e.g., positioning tooth 262c, thereby preventing rotation of winding member 232 in the cable unwinding direction after positioning pawl 256 disengages from positioning teeth 262b) and a disengaged position shown in FIG. 25A for disengaging from the plurality of positioning teeth 262 (thereby allowing rotation of winding member 232). A biasing member in the form of a torsion spring 258 biases pawl member 255 so that positioning pawl 256 is urged toward positioning teeth 262 and tooth engaging pawl 257 is urged away from positioning teeth 262. Positioning member 254 and positioning pawl 256 form a positioning unit 234 (FIG. 24) for maintaining winding member 232 in selected ones of a plurality of operating positions.

As shown in FIGS. 22 and 23, a cable winding lever 238 is mounted to support shaft 246 through a bushing 280 and a washer 281 for rotation between a start position shown by a solid line in FIG. 22 and a finish position shown by a broken line in FIG. 22. A bolt 241 screws into a threaded opening 283 in the tip of support shaft 246 to hold winding lever 238 in place. A biasing member such as a torsion spring 275 biases winding lever 238 toward the start position. An operating knob 238a is provided at the outer end of winding lever 238.

A drive pawl 259 is rotatably mounted to cable winding lever 238 through a pivot shaft 266 such that drive pawl 259 is located at the opposite end of cable winding lever 238 across from support shaft 246. A biasing member in the form of a torsion spring 267 biases drive pawl 259 toward engagement with the plurality of drive teeth 254, shown by a broken line in FIG. 24. However, pawl control plate 261 has an abutting portion 261a to maintain drive pawl 259 in the disengaged position shown by a solid line in FIG. 24 when winding lever 238 is located in the start position. When the rider rotates winding lever 238 from the start position toward the finish position, the tip of drive pawl 259 moves off from abutting portion 261a and rotates toward the engaged position.

As shown in FIGS. 23 and 25A, a release lever 236 has the form of a joystick that includes a lever body 268 comprising an operating knob 268a and a generally spherical pivot portion 268b mounted within a socket 269 secured to bracket 240. Pivot portion 268b moves along a generally spherical guide surface 269a of socket 269 so that lever body 268 moves in at least two dimensions shown by broken lines in FIG. 22. An intermediate member 270 is pivotably coupled between pivot portion 268b and pawl member 255 so that positioning pawl 256 and tooth engaging pawl 257 may move between their engaged and disengaged positions in a manner described below. Spring 258 biases release lever 236 to a start position shown by a solid line in FIG. 22 as a result of the biasing force applied to release lever 236 through pawl member 255 and intermediate member 270.

As shown in FIG. 25A, intermediate member 270 includes a first link member 270a and a second link member 270b, wherein first link member 270a is pivotably connected to the outer periphery of pivot portion 268b of release lever body 268 through a universal joint 272a, and second link member 270b is pivotably connected to pawl member 255 through a universal joint 272b. First link member 270a is pivotably connected to second link member 270b by any suitable means, such as by another universal joint. If desired, first and second link members 270a and 270b may be replaced with a tensionable and/or releasable member such as a wire or a rope.

FIGS. 25A-25C are schematic views illustrating a cable releasing operation. When the rider moves operating knob 268a of release lever 236 from the start position shown in FIG. 25A to the finish position shown in FIG. 25B, pivot portion 268b rotates around the center of guide surface 269a, pivot portion 268b pulls intermediate member 270, and pawl member 255 rotates counterclockwise to move positioning pawl 256 from the engaged position to the disengaged position and to move tooth engaging pawl 257 from the disengaged position to the engaged position. As a result, positioning pawl 256 disengages from positioning tooth 262b, and winding member 232 and positioning member 254 rotate in the cable releasing direction until tooth engaging pawl 257 engages positioning tooth 262c as shown in FIG. 25B.

When the rider releases release lever 236, spring 258 rotates pawl member 255 clockwise so that positioning pawl 256 moves from the disengaged position to the engaged position and tooth engaging pawl 257 moves from the engaged position to the disengaged position. As a result, tooth engaging pawl 257 disengages from positioning tooth 262c, and winding member 232 and positioning member 254 rotate in the cable releasing direction until positioning pawl 256 engages positioning tooth 262d as shown in FIG. 25C, thereby setting winding member 232 in a destination operating position. At the same time, pawl member 255 pulls intermediate member 270 to move release lever 236 back to the start position.

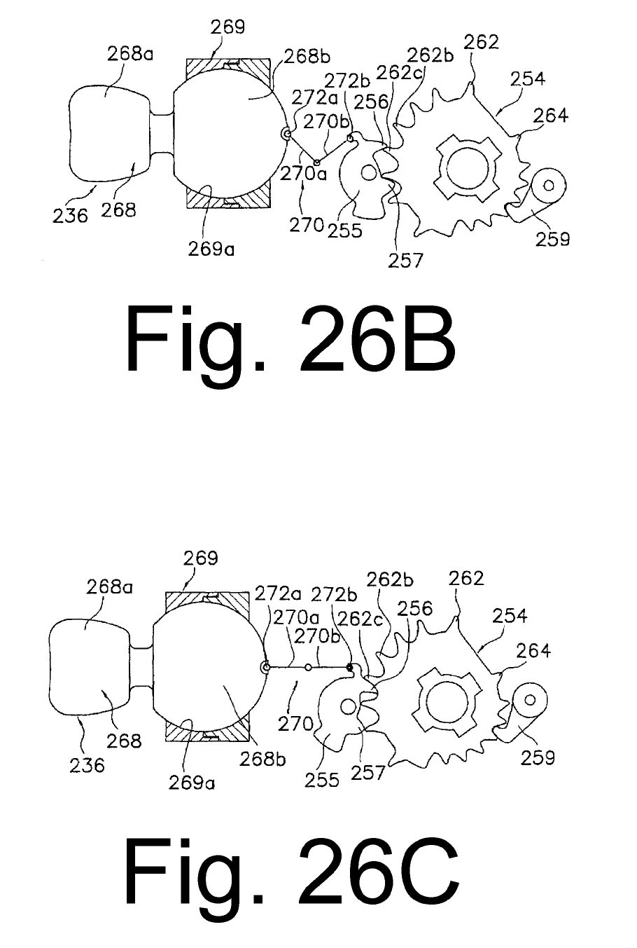

FIGS. 26A-26C are schematic views illustrating a cable winding operation. When the rider moves winding lever 238 from the start position toward the finish position, the tip of drive pawl 259 moves away from abutting portion 261a of pawl control plate 261, and drive pawl 259 is biased by spring 267 to engage drive teeth 264 as shown in FIG. 26A. Continued movement of winding lever 238 causes winding member 232 and positioning member 254 to rotate in the cable pulling direction (clockwise in FIG. 26A). During this time, positioning tooth 262c presses against positioning pawl 256 as shown in FIG. 26B so that pawl member 255 rotates counterclockwise to the disengaged position. First and second link members 270a and 270b of intermediate member 270 bend at their connecting portions to prevent release lever 236 from being moved. After positioning tooth 262c passes under positioning pawl 256, pawl member 255 rotates clockwise so that positioning pawl 256 moves back to the engaged position. If the rider releases winding lever 238 at this time, then winding member 232 and positioning member 254 rotate counterclockwise until positioning pawl 256 engages positioning tooth 262c, and winding member 232 is set at the destination operating position as shown in FIG. 26C. If the rider continues moving release lever 238, then the process repeats so that winding member 232 moves through a plurality of destination positions.

While the above is a description of various embodiments of inventive features, further modifications may be employed without departing from the spirit and scope of the present invention. For example, while the disclosed embodiments were used to shift derailleur transmissions, the concepts also could be applied to other control devices, such as internal hub transmissions. While the mounting members of the shift control devices were separated from the brake levers, the mounting members could be formed integrally with the brake lever assemblies. The size, shape, location or orientation of the various components may be changed as desired. Components that are shown directly connected or contacting each other may have intermediate structures disposed between them. The functions of one element may be performed by two, and vice versa. The function of one element may be performed by another, and functions may be interchanged among the elements. The structures and functions of one embodiment may be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the scope of the invention should not be limited by the specific structures disclosed or the apparent initial focus or emphasis on a particular structure or feature.

What is claimed is:

1. A shift operating device for a bicycle comprising:
a mounting member structured to be mounted to the bicycle;
a cable coupling member coupled to the mounting member for moving a cable in a cable pulling direction and a cable releasing direction;
a positioning unit that selectively maintains the cable coupling member in a plurality of operating positions;
a first operating member that moves in a first direction and in a second direction different from the first direction; and
a transmission unit that transmits movement of the first operating member to the positioning unit such that the cable coupling member moves from an origin operating position toward a destination operating position when the first operating member moves in either of both the first direction and the second direction.

2. The device according to claim 1 wherein the cable coupling member moves to a plurality of destination operating positions in response to a single movement of the first operating member in one of the first direction or the second direction from a first operating member start position to a first operating member finish position.

3. The device according to claim 1 wherein the first operating member has a neutral position and moves in the first direction and the second direction from the neutral position.

4. The device according to claim 1 wherein the transmission unit includes an intermediate member that moves in a third direction in response to movement of the first operating member in the first direction and the second direction.

5. The device according to claim 4 further comprising a first one-way clutch that communicates movement of the first operating member to the intermediate member only when the first operating member moves in the first direction.

6. The device according to claim 5 further comprising a second one-way clutch that communicates movement of the first operating member to the intermediate member only when the first operating member moves in the second direction.

7. The device according to claim 4 wherein the positioning unit comprises:
a plurality of abutments that move integrally with the cable coupling member; and
a positioning member that engages the plurality of abutments to maintain the cable coupling member in selected ones of the plurality of operating positions.

8. The device according to claim 7 wherein movement of the intermediate member in the third direction causes the positioning member to disengage from an engaged one of the plurality of abutments so that the cable coupling member moves away from an origin operating position.

9. The device according to claim 8 further comprising a release member that communicates movement of the intermediate member to the positioning member.

10. The device according to claim 9 wherein movement of the cable coupling member causes the release member to move so that the positioning member reengages one of the plurality of abutments to maintain the cable coupling member in the destination operating position.

11. The device according to claim 9 wherein the intermediate member and the release member are coupled for relative movement toward and away from each other.

12. The device according to claim 11 wherein the intermediate member includes a plurality of intermediate member inclined surfaces, wherein the release member includes a plurality of release member inclined surfaces, and wherein the plurality of intermediate member inclined surfaces engage the plurality of release member inclined surfaces to cause the intermediate member and the release member to movement away from each other.

13. The device according to claim 12 wherein the intermediate member rotates relative to the release member to cause the intermediate member and the release member to move away from each other.

14. The device according to claim 13 further comprising a biasing member that biases at least one of the intermediate member or the release member toward the other one of the intermediate member or the release member.

15. The device according to claim 13 wherein the release member is disposed between the intermediate member and the cable coupling member.

16. The device according to claim 13 further comprising a biasing member that biases the cable coupling member in the cable releasing direction.

17. The device according to claim 13 wherein movement of the first operating member in both the first direction or the second direction causes the cable coupling member to rotate in the cable releasing direction.

18. The device according to claim 17 further comprising a second operating member that causes the cable coupling member to rotate in the cable pulling direction.

19. The device according to claim 8 further comprising:
a first pivot shaft; and
a second pivot shaft spaced apart from the first pivot shaft;
wherein the first operating member pivots around the first pivot shaft when the first operating member moves in the first direction; and
wherein the first operating member pivots around the second pivot shaft when the first operating member moves in the second direction.

20. The device according to claim 19 wherein the first operating member includes a first guide that engages the first pivot shaft and a second guide that engages the second pivot shaft, and further comprising a biasing member that biases the first operating member so that the first pivot shaft engages an end of the first guide and the second pivot shaft engages an end of the second guide.

21. The device according to claim 20 wherein the first guide has an arcuate shape.

22. The device according to claim 21 wherein the second guide has an arcuate shape.

23. The device according to claim 19 further comprising a support shaft spaced apart from the first pivot shaft and the second pivot shaft, wherein the cable coupling member rotates around the support shaft.

24. The device according to claim 8 wherein movement of the cable coupling member causes the transmission unit to move so that the positioning member reengages one of the plurality of abutments to maintain the cable coupling member in the destination operating position.

25. The device according to claim 24 wherein the plurality of abutments comprise a plurality of teeth that move integrally with the cable coupling member, and wherein the positioning member comprises a pawl.

26. The device according to claim 25 wherein the pawl comprises:
a positioning pawl that engages one of the plurality of teeth to maintain the cable coupling member in one of the plurality of operating positions; and
a tooth engaging pawl that engages one of the plurality of teeth when the positioning pawl disengages from a previously engaged tooth.

27. The device according to claim 26 wherein movement of the cable coupling member causes one of the plurality of teeth to engage the tooth engaging pawl to cause the positioning pawl to engage another one of the plurality of teeth to maintain the cable coupling member in a destination operating position.

28. The device according to claim 27 wherein the positioning pawl rotates integrally with the tooth engaging pawl so that movement of the intermediate member in the third direction causes the positioning pawl to rotate to disengage from one of the plurality of teeth, and movement of the cable coupling member causes one of the plurality of teeth to contact the tooth engaging pawl and rotate the tooth engaging pawl so that the positioning pawl engages another one of the plurality of teeth to maintain the cable coupling member in a destination operating position.

29. The device according to claim 8 wherein the first operating member has at least a two-dimensional freedom of movement.

30. The device according to claim 29 wherein the first operating member comprises a joystick.

31. The device according to claim 29 wherein the intermediate member is pivotably coupled to the first operating member.

32. The device according to claim 31 wherein the intermediate member is coupled to the first operating member through a universal joint.

33. The device according to claim 29 wherein the intermediate member is pivotably coupled to the positioning member.

34. The device according to claim 33 wherein the intermediate member is coupled to the positioning member through a universal joint.

35. The device according to claim 29 wherein the plurality of abutments comprise a plurality of teeth that move integrally with the cable coupling member, and wherein the positioning member comprises a pawl.

36. The device according to claim 35 wherein the pawl comprises:
a positioning pawl that engages one of the plurality of teeth to maintain the cable coupling member in one of the plurality of operating positions; and
a tooth engaging pawl that engages one of the plurality of teeth when the positioning pawl disengages from a previously engaged tooth.
